(19) United States
(12) Patent Application Publication
(10) Pub. No.: US 2008/0176633 A1
(43) Pub. Date: Jul. 24, 2008

(54) Gaming machine providing an award by combination of symbols

(76) Inventor: Hiro Sakuma, Tokyo (JP)

Correspondence Address: ARENT FOX LLP, 1050 CONNECTICUT AVENUE, N.W., SUITE 400, WASHINGTON, DC, 20036, US

(21) Appl. No.: 12/003,514

(22) Filed: Dec. 26, 2007

(30) Foreign Application Priority Data
Dec. 28, 2006 (JP) 2006-354581

(51) Int. Cl. A63F 9/24; A63F 13/00

(52) U.S. Cl. 463/20

(57) ABSTRACT

A gaming machine includes a memory, a display device and a controller. The display device has N frames and an N+1th frame. The controller is configured with logic to: (a) accept a start of the game, and determine symbol data; (b) cause the display device to display symbols in the N frames in accordance with the determined symbol data to perform a first game; (c) determine symbol data to be used for the N+1th frame, and cause the display device to display a symbol in the N+1th frame in accordance with the determined symbol data; (d) when the displayed symbol is a specific symbol, determine symbol data and cause the display device to display symbols in the N frames in accordance with the determined symbol data to perform a second game with rearrangement; and (e) provide an award in accordance with the symbols rearranged in the N frames.

This application is based on and claims the benefit of priority from Japanese Patent Application No. 2006-354581, filed on 28 Dec. 2006, the content of which is incorporated herein by reference.

### BACKGROUND OF THE INVENTION

1. Field of the Invention

The present invention relates to a gaming machine providing an award by a combination of symbols.

2. Related Art

Conventionally, U.S. Pat. No. 6,093,102 has been known which discloses a slot machine in which an award is provided when a combination of symbols rearranged on a winning line matches a predetermined combination of symbols. In addition, besides the slot machine described above, U.S. Pat. No. 6,604,999 has been known which discloses a slot machine in which an award is provided based on the number of symbols rearranged without any concept of a line such as the winning line. Moreover, International Patent Application No. PCT/AU99/01059 has been known which discloses a technique associated with rendered effects that allow players to feel more expected about the outcome of a game by using recent imaging techniques and the like in addition to providing an award in response to the number of symbols, combinations, and the like.

However, regarding the conventional games such as those described above, even though these games are accompanied with images to be displayed, an award is provided based on a combination of winning symbols which are rearranged. Alternatively, symbols are displayed in a predetermined frame, and then an award is only awarded in response to the number of symbols displayed or combinations thereof.

### SUMMARY OF THE INVENTION

The present invention has an object of providing a gaming machine which can raise more players' expectations based on symbol rearrangement and which can further improve entertainment properties.

In an aspect of the present invention, a gaming machine is provided, which includes a memory, a display device and a controller. The memory stores symbol data corresponding to a plurality of types of symbols used in a game. The display device has N frames for displaying symbols and an N+1th frame for displaying a symbol separately from the N frames. The controller is configured with logic to: (a) accept a start of the game, and randomly determine a plurality of symbol data; (b) cause the display device to display symbols in the N frames in accordance with the determined plurality of symbol data so as to perform a first game; (c) randomly determine symbol data to be used for the N+1th frame separately from the first game, and cause the display device to display a symbol in the N+1th frame in accordance with the determined symbol data; (d) when the displayed symbol is a specific symbol, randomly determine a plurality of symbol data and cause the display device to display symbols in the N frames in accordance with the determined plurality of symbol data so as to perform a second game with rearrangement; and (e) provide an award in accordance with the symbols rearranged in the N frames.

According to the gaming machine described above, when the symbol determined separately after the first game is the specific symbol, the symbols of the first game are rearranged. In this way, it is possible to raise more players' expectations toward the award and further improve entertainment properties.

In another aspect of the present invention, a gaming machine is provided, in which the controller provides for the second game a higher award than an award to which the first game is entitled.

Based on the foregoing, when the symbol data of the first game are further rearranged, the controller provides an award higher than the award which is based on the previous rearrangement. Therefore, it can raise more players' expectations toward the award and can further improve entertainment properties.

In still another aspect of the present invention, a gaming machine is provided, which includes a memory, a display device and a controller. The memory stores symbol data corresponding to a plurality of types of symbols used in a game. The display device has N frames for displaying symbols and an N+1th frame for displaying a symbol separately from the N frames. The controller is configured with logic to: (a) accept a start of the game, and randomly determine a plurality of symbol data; (b) cause the display device to display symbols in the N frames in accordance with the determined plurality of symbol data so as to perform a first game; (c) perform a determination; (d) cause the display to display the N+1th frame in accordance with the determination; (e) randomly determine symbol data to be used for the N+1th frame separately from the first game, and cause the display device to display a symbol in the N+1th frame in accordance with the determined symbol data; (f) when the displayed symbol is a specific symbol, randomly determine a plurality of symbol data and cause the display device to display symbols in the N frames in accordance with the determined plurality of symbol data so as to perform a second game with rearrangement; and (g) provide an award in accordance with the symbols rearranged in the N frames.

Based on the foregoing, when the symbol data of the first game are further rearranged, a separate determination is performed, then the invention newly introduces the N+1th frame on the display based on the determination, and displays the symbol which is separately determined. When the symbol is a specific symbol, the symbol data of the first game is further rearranged, it can raise more players' expectations toward the award and can further improve entertainment properties.

In yet another aspect of the present invention, a gaming machine is provided, which includes a memory, a display device and a controller. The memory stores symbol data corresponding to a plurality of types of symbols used in a game. The display device has N frames for displaying symbols and an N+1th frame for displaying a symbol separately from the N frames. The controller is configured with logic to: (a) accept a start of the game, and randomly determine a plurality of symbol data; (b) cause the display device to display symbols in the N frames in accordance with the determined plurality of symbol data so as to perform a first game; (c) perform a determination; (d) cause the display to display the N+1th frame with rendered effects in accordance with the determination and information related to notification of a possible win; (e) randomly determine symbol data to be used for the N+1th frame separately from the first game, and cause the display device to display a symbol in the N+1th frame in accordance with the determined symbol data; (f) when the displayed symbol is a specific symbol, randomly determine a plurality of symbol data and cause the display device to display symbols in the N frames in accordance with the determined plurality of symbol data so as to perform a second game with rearrangement; and (g) provide an award in accordance with the symbols rearranged in the N frames.

Based on the foregoing, when the symbol data of the first game are further rearranged, a separate determination is performed, and then the invention newly introduces the N+1th frame on the display accompanied with the rendered images, and displays the information to notify a possibility of an award based on the determination and displays the symbol data which are separately determined. When the symbol is a specific symbol, the symbol data of the first game is further rearranged, it can raise more players' expectations toward the award and can further improve entertainment properties.

The present invention can raise more players' expectations and can further improve entertainment properties by further rearranging the symbol data based on a specific symbol and by introducing the new frame to display the symbol.

### BRIEF DESCRIPTION OF THE DRAWINGS

FIG. 1 is a flow chart showing operations according to the embodiment;

FIG. 2 is a perspective diagram showing a general view of the video slot machine according to the embodiment;

FIG. 3 is a block diagram showing an electronic configuration of the video slot according to the embodiment;

FIG. 4 shows a symbol data table used for the video slot machine according to the embodiment;

FIG. 5 shows an award table used for the video slot machine according to the embodiment;

FIG. 6 shows a table for performing a second game used for the video slot machine according to the embodiment;

FIG. 7 shows a symbol data table of the frame for displaying an N+1th symbol used for the video slot machine according to the embodiment;

FIG. 8 is a main flow chart illustrating a process flow of the video slot machine according to the embodiment;

FIG. 9 is a main flow chart illustrating a modified example of a process flow of the video slot machine according to the embodiment;

FIG. 10 is a flow chart illustrating a flow of a separate random determination, displaying of images, and display processing of the video slot machine according to the embodiment;

FIG. 11 is a diagram showing an image displayed on the video slot machine (before starting) according to the embodiment;

FIG. 12 is a diagram showing an image displayed on the video slot machine (while rearranging) according to the embodiment;

FIG. 13 is a diagram showing an image displayed on the video slot machine (after rearranging) according to the embodiment;

FIG. 14 is a diagram showing an image displayed on the video slot machine (displaying a door 320 to the frame for displaying the fourth symbol) according to the embodiment;

FIG. 15 is a diagram showing an image displayed on the video slot machine (the entire image becomes darker) according to the embodiment;

FIG. 16 is a diagram showing an image displayed on the video slot machine (a thunder 322 hits the door 320 to the frame for displaying the fourth symbol) according to the embodiment;

FIG. 17 is a diagram showing an image displayed on the video slot machine (the door 320 to the frame for displaying the fourth symbol is opened) according to the embodiment;

FIG. 18 is a diagram showing an image displayed on the video slot machine (a sword is displayed in the frame for displaying the fourth symbol) according to the embodiment;

FIG. 19 is a diagram showing an image displayed on the video slot machine (the display of the frame for displaying the fourth symbol is spinning) according to the embodiment;

FIG. 20 is a diagram showing an image displayed on the video slot machine (spinning of the display of the frame for displaying the fourth symbol is over and “Re-spin” is displayed) according to the embodiment;

FIG. 21 is a diagram showing an image displayed on the video slot machine (the frame for displaying three symbols is in the process of rearranging) according to the embodiment;

FIG. 22 is a diagram showing an image displayed on the video slot machine (the symbols are rearranged in the frame for displaying three symbols and the frame for displaying the fourth symbol spins again) according to the embodiment; and

FIG. 23 is a diagram showing an image displayed on the video slot machine (the display of the frame for displaying the fourth symbol is stopped and “2” is displayed) according to the embodiment.

### DETAILED DESCRIPTION OF THE INVENTION

Embodiments of the present invention are described below.

### a. General Description of the Embodiments of the Present Invention

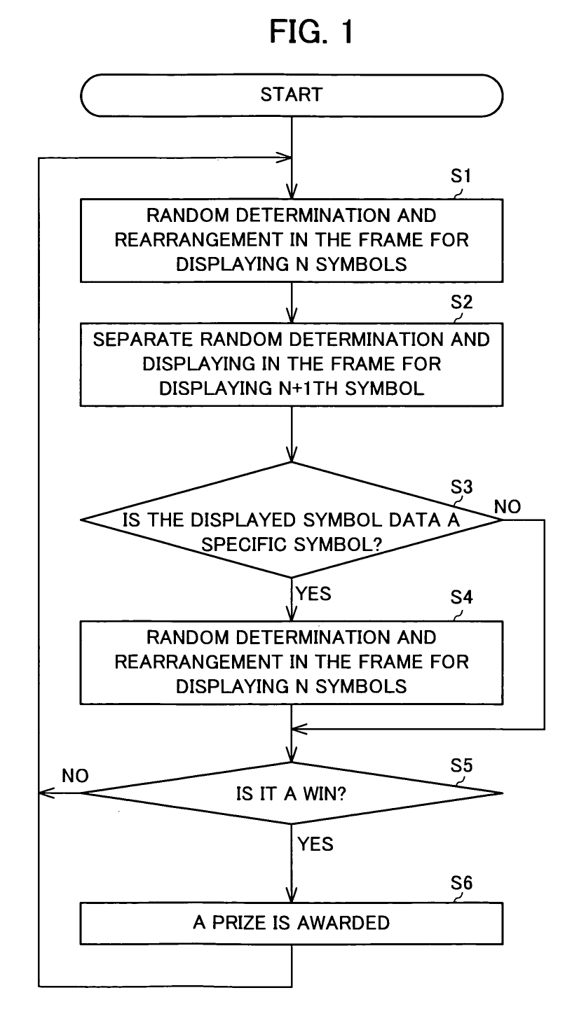

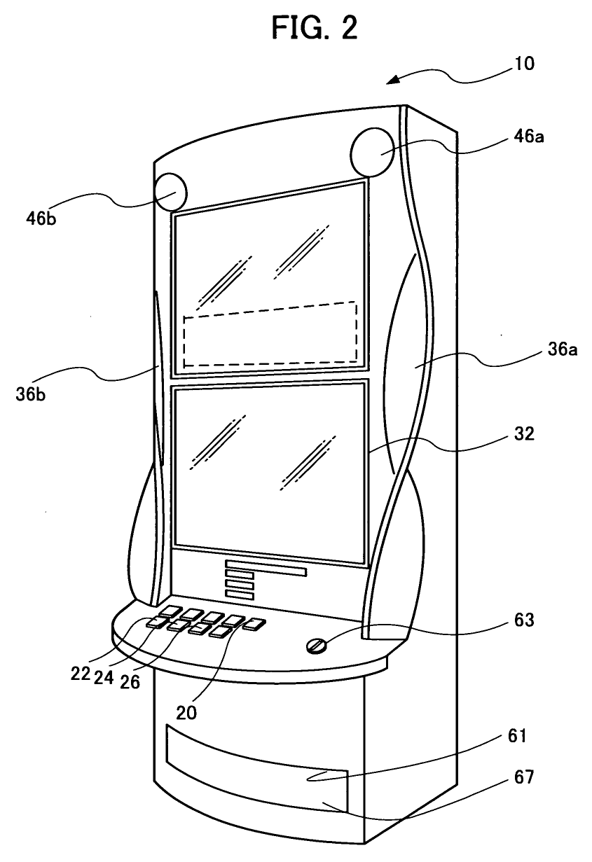

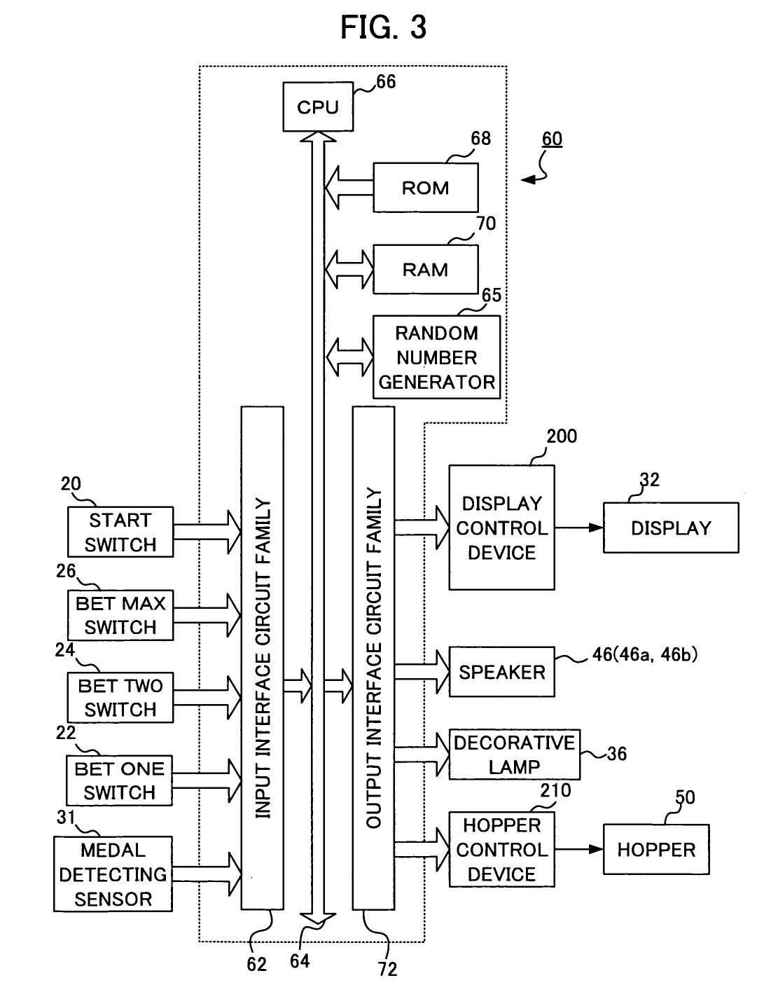

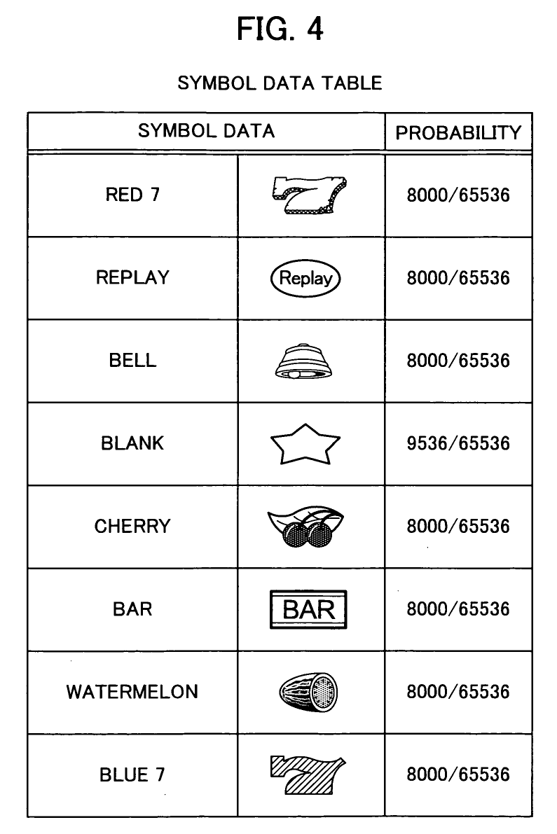

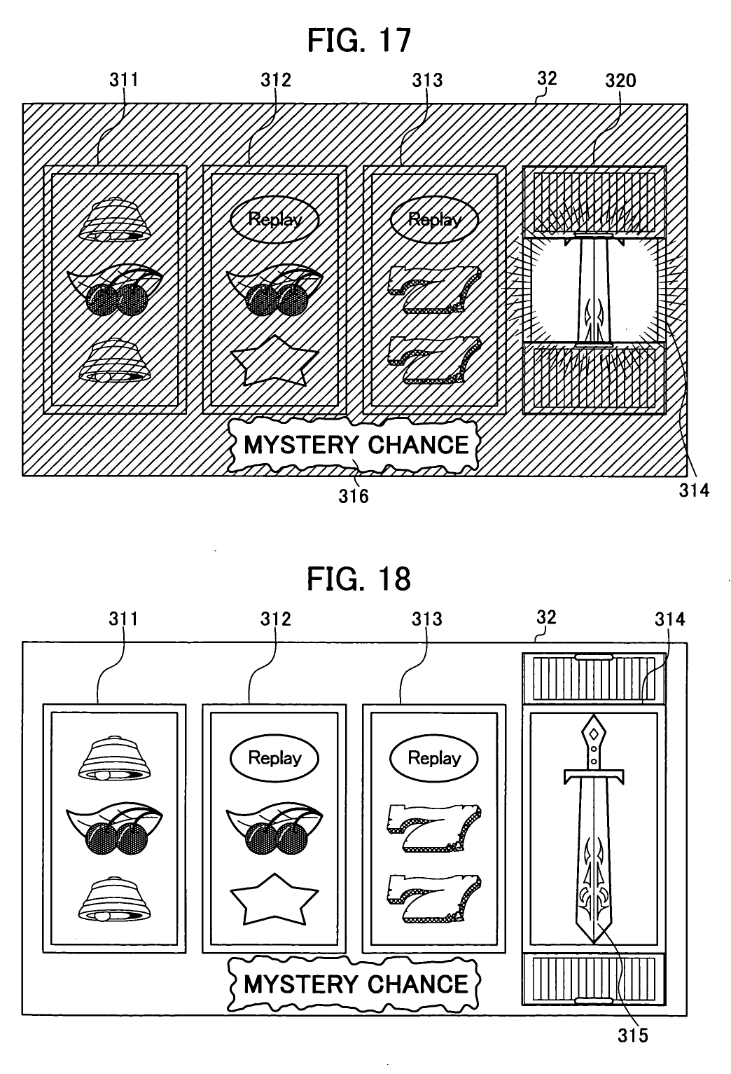

As a detailed description of a preferred embodiment of the one of the gaming machines of the present invention, a so-called video slot machine is exemplified and explained according to FIGS. 1 to 23. The video slot machine 10 (FIG. 2) is provided with a display 32 (FIG. 2) having ROM (abbreviation of Read Only Memory, hereinafter, the same) 68 (FIG. 3) storing symbol data corresponding to a plurality of types of symbols (FIG. 4) which are used in a game, and a frame for displaying three symbols (a left reel 311, a center reel 312, and a right reel 313) (FIG. 11), a frame for displaying a fourth symbol (a fourth real 314) (FIG. 17), a start switch 20 (FIG. 2) for starting the game, and a CPU 66 (abbreviation for Central processing unit, hereinafter, the same) (FIG. 3) for determining a plurality of symbol data randomly and controlling the game.

The controller (the CPU 66) starts the game, determines randomly a plurality of symbol data to be displayed among symbol data (FIG. 4) stored in a memory, and displays the plurality of the determined symbol data in the frame for displaying three symbols (the left reel 311, the center reel 312, and the right reel 313) on the display 32 (FIG. 11). Then, symbol data displayed in the frame for displaying the fourth symbol (the fourth reel 314) are randomly determined separately, and based on the determined symbol data, the symbols are displayed in the frame for displaying the fourth symbol (the fourth reel 314) (FIG. 20). If the symbol is a specific symbol, the symbol data are rearranged in the frame for displaying three symbols (the left reel 311, the center reel 312, and the right reel 313) in the state of rearrangement in the frame for displaying three symbols (the left reel 311, the center reel 312, and the right reel 313), and then an award is awarded in response to the contents of the symbol data which are rearranged in the frame for displaying three symbols (the left reel 311, the center reel 312, and the right reel 313). More details are explained with reference to the figures as follows.

FIG. 1 is a flow chart describing the operation of the controller (a CPU 66) in one embodiment of the present invention.

When the CPU 66 receives an operation signal to start the game, a plurality of symbol data to be displayed among the symbol data (FIG. 4) stored in a memory is determined randomly. The CPU 66 performs a first game which rearranges the determined plurality of symbol data in the frame for displaying N symbols on the display 32 (Step S1). Then, symbol data are randomly determined separately and displayed in the frame for displaying an N+1th symbol (Step S2). The determination is done whether the displayed symbol data is a specific symbol or not (Step S3). If it is not a specific symbol, the CPU 66 advances the processing to Step S5. If it is a specific symbol, the CPU 66 performs a second game which determines randomly a plurality of symbol data among symbol data stored in the memory (FIG. 4) in the state of rearrangement of the first game, and which rearranges the determined plurality of symbol data in the frame for displaying N symbols on the display 32 (Step S4). Then, is the CPU 66 determines whether the content of the symbol data which are rearranged in the frame for displaying N symbols is winning or not (Step S5). When it is winning, an award is provided (Step S6).

### b. The Constitution of a Video Slot Machine

The external appearance of the video slot machine 10 is described, which is one embodiment of the present invention.

FIG. 2 is a perspective diagram showing a general view of the video slot machine 10. Although, in this embodiment, a video slot machine using medals as a gaming medium is described as an example, a gaming medium for the gaming machine of the present invention may include coins, medals, tokens, cards storing valuable information of games, and the like.

The display 32 for displaying images relating to a game is provided at the front of the video slot machine 10. A plurality of the rearranged symbols is displayed on the display 32 of the video slot machine 10.

Also, a medal slot 63 is provided in the vicinity of a right side at the front of the video slot machine 10. A medal discharge slot 61 and a medal tray 67 are provided on the lower side at the front of the video slot 10, respectively. A game can be started by a player inserting a medal into the medal slot 63. Then, medals are discharged from the medal discharge slot 61 in response to the gaming result and collected in the medal tray 67. As described later, a medal detecting sensor 31 (see FIG. 3) is embedded inside the video slot machine 10 with which the medal slot 63 is provided. The medal detecting sensor 31 can detect the time a player inserts a medal into the video slot machine 10.

In addition, speakers 46a and 46b are provided on the upper side of the video slot machine 10. The speakers 46a and 46b generate sound effects and the like in accordance with the progress of the game. Decorative lamps 36a and 36b are provided on both right and left sides of the substantially center portion of the video slot machine 10. The decorative lamps 36a and 36b emit light in accordance with the progress of the game.

A start switch 20, a BET MAX switch 26, a BET TWO switch 24, and a BET ONE switch 22, which are used for advancing the game, are disposed on the lower side of the display 32. The BET MAX switch 26, the BET TWO switch 24, and the BET ONE switch 22 are used for starting a game by a player. The BET MAX switch 26 is used for betting the maximum number of medals at one time. The BET TWO switch 24 is used for betting two medals at one time. The BET ONE switch 22 can increase the number of medals to be inserted for a game corresponding to the number of times the BET ONE switch 22 is pressed.

### c. The Constitution of the Control Unit of the Video Slot Machine

Next, the constitution of the control unit of the video slot machine 10 is described below. FIG. 3 is a block diagram of a control circuit of the video slot machine 10, which is one embodiment of the present invention.

A main control circuit 60 is configured to be connected to the CPU 66, ROM 68, Random Access Memory (hereafter, RAM) 70, a random number generator 65, an input interface circuit family 62, and an output interface circuit family 72 through an input/output bus 64. The input/output bus 64 inputs and outputs a control signal or an address signal to the CPU 66.

The CPU 66 reads and writes data to each element and device connected to the input/output bus 64 based on a computer program stored in the ROM 68, and processes in cooperation with each element and device. A timer (not shown) is also provided inside the CPU 66.

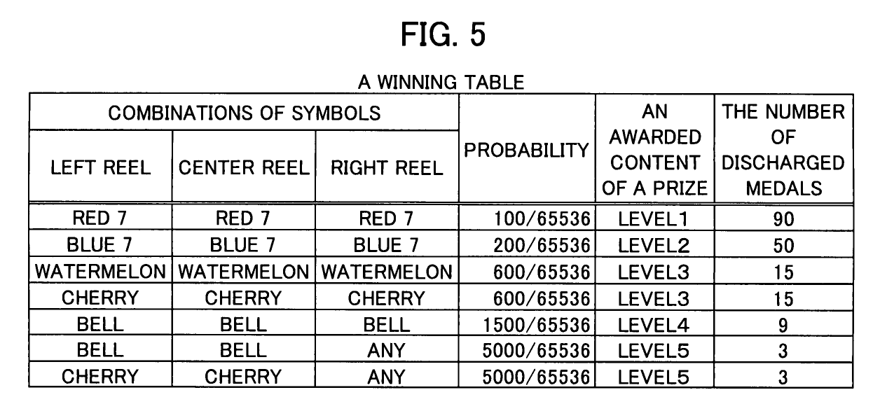

The ROM 68 and the RAM 70 as storing means are also connected to the input/output bus 64. The ROM 68 stores a control program for controlling an entire flow of the game of the video slot machine 10. The ROM 68 also stores initial data for executing a control program, a program for controlling an operational pattern of blinking of the decorative lamp 36 (36a and 36b (see FIG. 2)) embedded in the video slot machine 10, a program for display control on the display 32, and the like. Furthermore, the ROM 68 stores a symbol data table (FIG. 4) correlating symbol data and the probability of symbol data to be determined, an award table (FIG. 5), which correlates combinations of symbols and the number of discharged medals, and the like.

The random number generator 65 for generating a random number is also connected to the input/output bus 64. When an instruction for generating a random number is transmitted to the random number generator 65 from the CPU 66, the random number generator 65 generates a certain range of random numbers, and transmits a signal indicating the value of the random number to the input/output bus 64. In the CPU 66, random determinations, which are described below, are done according to the generated random numbers. The random number generated from the random number generator 65 is stored in the RAM 70.

In this embodiment, random numbers are generated by the random number generator 65 connected through the CPU 66 and input/output bus 64. However, the present invention is not limited to this embodiment and may be configured to execute random number generation on an operational program of the CPU 66 as a means for generating random numbers. In this case, the random number generator 65 can be omitted.

The start switch 20, the BET MAX switch 26, the BET TWO switch 24, and the BET ONE switch 22 are connected with the input interface circuit family 62. When these switches are activated by a player's pressing operation, each switch transmits a signal indicative of pressing operation to the input interface circuit family 62. The input interface circuit family 62 supplies the signal to the input interface circuit family 64.

The abovementioned medal detecting sensor 31 is also connected with the input interface circuit family 62. A detection signal from the medal detecting sensor 31 is supplied to the input/output bus 64 after converting a certain signal by the input interface circuit family 62.

A display control device 200 is also connected with the output interface circuit family 72. The display control device 200 transmits a drive signal for driving the display 32 connected with the display control device 200 based on an instruction for displaying images, which is generated from the main control circuit 60.

The speaker 46 (46a and 46b) and the decorative lamp 36 (36a and 36b) are connected with the output interface circuit family 72. The output interface circuit family 72 controls each of the abovementioned devices by supplying a drive signal, a drive electric signal, and the like to each device, in response to the result of processing by the CPU 66.

Furthermore, a hopper control device 210 is also connected with the output interface circuit family 72. The hopper control device 210 transmits a drive signal for driving a hopper 50 connected to the hopper control device 210 based on an instruction for medal discharge, which is generated from the main control circuit 60.

### d. Symbol Data Table

FIG. 4 shows a symbol data table which correlates symbol data and the probability of symbol data to be determined. “Symbol data” refers to symbol data which correspond to multiple types of symbols used in the game. “Probability” refers to a ratio for determination of the symbol data.

### e. Award Table

FIG. 5 shows the correlation between the probability of combinations of symbols and information for realization of combinations of symbols. Information for realization of combinations of symbols includes “an awarded content for a win” and “the number of discharged medals”.

“Combinations of symbols” indicates combinations of three symbols, which are arranged on an award line when symbols which are intended to be provided for an award, are stopped in the frame for displaying three symbols (the left reel 311, the center reel 312, and the right reel 313). For example, if “Red 7” is on the award line of the left reel 311, “Red 7” is on the award line of the center reel 312, and “Red 7” is on the award line of the right reel 313, this combination indicates an award.

“Probability” is the probability that each combination is determined. The decision is performed by the extraction of random numbers. In the case that a random number value of 0 to 99 is extracted, then a combination of “Red 7” is selected. When a random number value is extracted, which falls in a range (for example, 13000 to 65535), the number is not regarded as a win.

“An awarded content of an award” is classified into sub-levels based on the number of discharged medals (that is, low probability) according to the combinations of symbols. For example, a combination of “Red 7” in the left reel 311, “Red 7” in the center reel 312, and “Red 7” in the right reel 313 discharges 90 medals, and it shows Level 1. A combination, for example, of “Cherry” in the left reel 311, “Cherry” in the center reel 312, and “ANY” in the right reel 313 discharges 3 medals, and it shows Level 5. In addition, “ANY” refers to any symbol.

“The number of discharged medals” refers to the number of discharged medals when a game results in a win. For example, when a combination is stopped at “Watermelon” in the left reel 311, “Watermelon” in the center reel 312, and “Watermelon” in the right reel 313, it receives 15 medals.

### f. A Table for Performing a Second Game

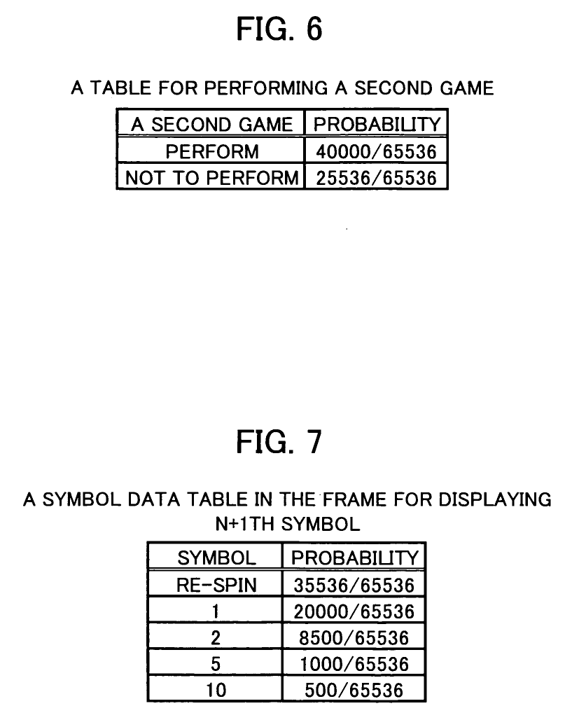

FIG. 6 shows a table for performing a second game, which relates probabilities to whether the second game is performed or not. This table is referred to in the case of determining whether the second game is performed or not.

### g. Symbol Data Table of the Frame for Displaying N+1th Symbol

FIG. 7 shows a symbol data table of the frame for displaying an N+1th symbol, which relates probabilities to symbol data displayed in the frame (the fourth reel 314) for displaying the fourth symbol. This table is referred to in the case of determining symbol data separately from the first game.

### h. Operation of a Video Slot Machine

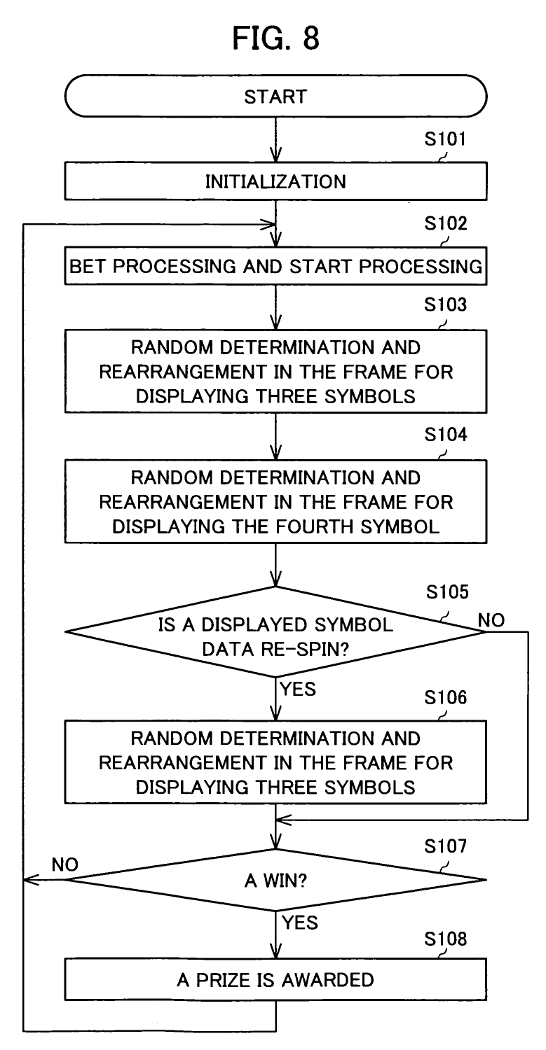

Processing to be performed in the main control circuit 60 described above is explained. FIG. 8 is a flow chart of a main processing to be performed in the main control circuit 60 of one embodiment of the present invention.

### i. A Main Flow Chart

Referring to a main flow chart shown in FIG. 8, a control operation of the CPU 66 as a controller is described.

Initially, in Step S11, the CPU 66 of the main control circuit 60 performs initialization at start-up of a game. The CPU 66 performs initialization such as for memory in the RAM 70. That is to say, the CPU 66 removes certain memory in the RAM 70 at the end of a game, deletes data in a writable area of the RAM 70 which was used at the previous game, and writes necessary parameters for a next game into a writing area of the RAM 70. Specifically, each flag turns to OFF and each counter turns to zero. Then, the process proceeds to Step S102.

At Step S102, the CPU 66 verifies that a player has started a game after BET operation. Specifically, the CPU 66 determines whether an operational signal of the start switch 20 is received or not after receiving the BET operation signal. If the operational signal of the start switch 20 is not received, the CPU 66 waits for the signal to be received. If the operational signal of the start switch 20 is received, the CPU 66 determines that the player has started the game. Then, the process proceeds to Step S103.

In Step S103, the CPU 66 performs the first game and determines a plurality of symbol data. Specifically, the CPU 66 determines a plurality of symbol data among a plurality of types of symbol data based on the symbol data table (FIG. 4) and the award table (FIG. 5), and rearranges these symbol data in the frame for displaying three symbols (the left 311, the center 312, and right reel 314). The CPU 66 stores this information, and then the process proceeds to Step S104.

In Step S104, the CPU 66 performs the second game and determines symbol data displayed in the frame of the fourth symbol (the fourth reel 314). Specifically, the CPU 66 determines symbol data based on the symbol data table of the frame for displaying the N+1th symbol, displays these symbol data in the frame of the fourth symbol (the fourth reel 314), and stores this information. Then, the process proceeds to Step S105.

In Step S105, the CPU 66 determines whether the displayed symbol data are “Re-spin” or not. Specifically, the CPU 66 determines whether the symbol data, which are determined and stored in Step S104, are “Re-spin” or not. If it is not “Re-spin”, the process proceeds to Step S107. If it is “Re-spin”, the process proceeds to Step S106.

In Step S106, the CPU 66 determines a plurality of symbol data. Specifically, the CPU 66 determines a plurality of symbol data among a plurality of types of symbol data based on the symbol data table (FIG. 4) and the award table (FIG. 5), and rearranges these symbol data in the frame for displaying three symbols (the left 311, the center 312, and right reel 314). The CPU 66 stores this information, and then the process proceeds to Step S107.

In Step S107, the CPU 66 determines whether a combination of symbols is winning or not. Specifically, the CPU 66 determines whether or not the combination of symbol data displayed in the frame for displaying three symbols (the left 311, the center 312, and right reel 314) is winning. If the combination of symbols is not winning, the process proceeds to Step S102. If the combination of symbols is winning, the process proceeds to Step S108.

In Step S108, the CPU 66 provides an award. Specifically, the CPU 66 provides an award based on the number of discharged medals of the award table (FIG. 5). Then, the process proceeds to Step S102.

### j. A Main Flow Chart for a Modified Example

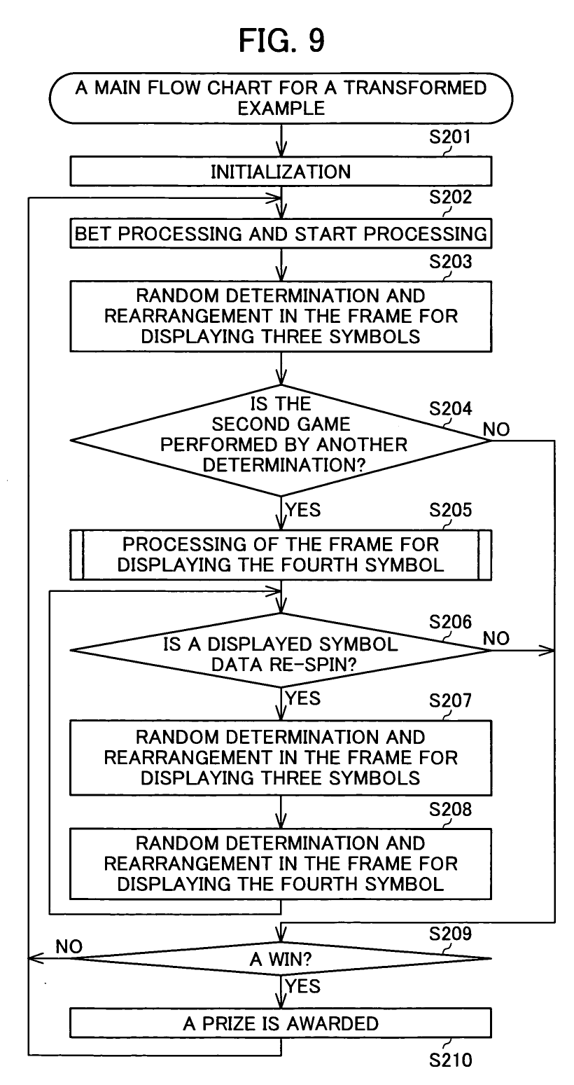

FIG. 9 shows a modified example from the main flow chart in FIG. 8. In this example, the controller (the CPU 66) newly introduces the frame for displaying the fourth symbol (the fourth reel 314) accompanied with images to be displayed, after determining whether the frame for displaying the fourth symbol (the fourth reel 314) is to be introduced. If the symbol in the frame for displaying the fourth symbol (the fourth reel 314) is “Re-spin”, the controller further determines the symbol in the frame for displaying the fourth symbol (the fourth reel 314) after rearranging the symbols in the frame for displaying three symbols (the left reel 311, the center reel 312, and the right reel 313). Then, the controller repeatedly rearranges the symbols in the frame for displaying three symbols (the left reel 311, the center reel 312, and the right reel 313). Referring to the main flow chart for a modified example in FIG. 9, the modified example is explained.

Initially, in Step S201, the CPU 66 of the main control circuit 60 performs initialization and the like for memory in the RAM 70 at start-up of a game (start-up of a game). That is to say, the CPU 66 removes certain memory in the RAM 70 at the end of a game, deletes data in a writable area of the RAM 70 which was used at the previous game, and writes necessary parameters for a next game into a writing area of the RAM 70. Specifically, each flag turns OFF and each counter turns to zero. Then, the process proceeds to Step S202.

In Step S202, the CPU 66 verifies that a player has started a game after BET operation. Specifically, the CPU 66 determines whether an operational signal of the start switch 20 is received or not after receiving the BET operation signal. If the operational signal of the start switch 20 is not received, the CPU 66 waits for the signal to be received. If the operational signal of the start switch 20 is received, the CPU 66 determines that the player has started the game. Then, the process proceeds to Step S203.

In Step S203, the CPU performs the first game and determines a plurality of symbol data. Specifically, the CPU 66 determines a plurality of symbol data among a plurality of types of symbol data based on the symbol data table (FIG. 4) and the award table (FIG. 5), and rearranges these symbol data in the frame for displaying three symbols (the left 311, the center 312, and right reel 314). The CPU 66 stores this information, and then the process proceeds to Step S204.

In Step S204, the CPU determines whether the second game is performed or not. Specifically, the CPU 66 determines whether the second game is performed or not based on a random number obtained from the random number generator 65 and the table for performing the second game. If the random number is 0 to 39999, the CPU 66 determines that the second game is performed, and then the process proceeds to Step S205. If the random number is 40000 to 65535, the CPU 66 determines that the second game is not performed, and then the process proceeds to Step S209.

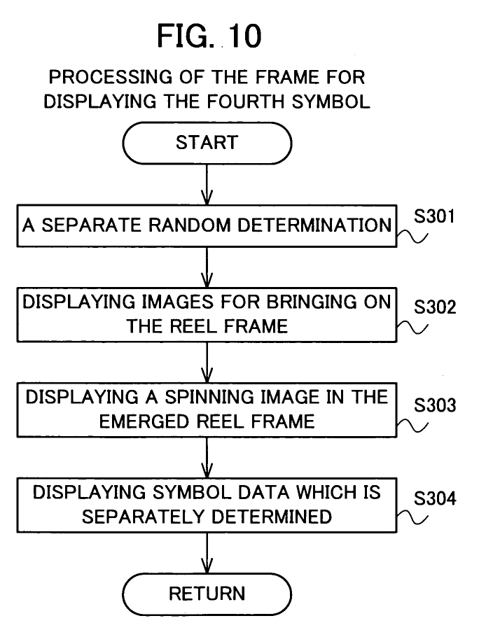

In Step S205, the CPU 66 displays an image to newly introduce the frame for displaying the fourth symbol (the fourth reel 314), performs the second game, and determines the symbol data displayed in the fourth symbol (the fourth reel 314). Specifically, the CPU 66 performs processing of the frame for displaying the fourth symbol (FIG. 10). Then, the process proceeds to Step S206.

In Step S206, the CPU 66 determines whether the displayed symbol data are “Re-spin” or not. Specifically, the CPU 66 displays the symbol data in the frame for displaying the fourth symbol, and determines whether the stored symbol data are “Re-spin” or not. If it is not “Re-spin”, the process proceeds to Step S209. If it is “Re-spin”, the process proceeds to Step S207.

In Step S207, the CPU 66 determines a plurality of symbol data. Specifically, the CPU 66 determines a plurality of symbol data among a plurality of types of symbol data based on the symbol data table (FIG. 4) and the award table (FIG. 5), and rearranges these symbol data in the frame for displaying three symbols (the left 311, the center 312, and right reel 314). The CPU 66 stores this information, and then the process proceeds to Step S208.

In Step S208, the CPU 66 determines symbol data displayed in the frame of the fourth symbol (the fourth reel 314). Specifically, the CPU 66 determines symbol data based on the symbol data table of the frame for displaying the N+1th symbol (FIG. 7), displays these symbol data in the frame of the fourth symbol (the fourth reel 314), and stores this information. Then, the process proceeds to Step S206.

In Step S209, the CPU 66 determines whether a combination of symbols is winning or not. Specifically, the CPU 66 rearranges the symbols in the frame for displaying three symbols (the left 311, the center 312, and right reel 314) and determines whether or not the combination of the stored symbol data is winning. If the combination of symbols is not winning, the process proceeds to Step S202. If the combination of symbols is winning, the process proceeds to Step S210.

In Step S210, the CPU 66 provides an award. Specifically, the CPU 66 provides an award based on the number of discharged medals of the award table (FIG. 5). On this occasion, the number of discharged medals is calculated according to the content (for example, 1, 2, 5, and 10: “1” indicates that the number of discharged medals is multiplied by 1; “2” indicates double; “5” indicates five times; “10” indicates ten times) in the frame for displaying the fourth symbol (the fourth reel 314). Then, the process proceeds to Step S202.

### k. Flow Chart for Processing of Frame for Displaying the Fourth Symbol

Referring to the flow chart shown in FIG. 10, a separate random determination, displaying of images, and display processing that the CPU 66 as a controller performs in the main flow chart is described.

In Step S301, the CPU 66 performs a separate random determination. Specifically, the CPU 66 determines symbol data based on the symbol data table of the frame for displaying the N+1th symbol (FIG. 7), and stores this information. Then, the process proceeds to Step S302.

In Step S302, the CPU 66 displays images for introducing the frame for displaying the fourth symbol (the fourth reel 314). Specifically, the CPU 66 displays a door 320 to the frame for displaying the fourth symbol (the fourth reel 314). Afterwards, the image on the display becomes darker, lightning 322 hits the door 320, and the door 320 is open, thereby displaying the images which show newly introducing the frame for displaying the fourth symbol (the fourth reel 314). Then, the process proceeds to Step S303.

In Step S303, the CPU 66 displays a spinning image displayed in the emerged frame for displaying the fourth symbol (the fourth reel 314). Specifically, the CPU 66 spins symbols as if the CPU 66 were determining symbols to be displayed in the frame for displaying the fourth symbol (the fourth reel 314). Afterwards, the process proceeds to Step S304.

In Step S304, the CPU 66 displays the symbol which is separately determined. Specifically, the CPU 66 displays the symbol, which is determined and stored in S301, in the frame for displaying the fourth symbol (the fourth reel 314). Then, the CPU 66 ends the process and proceeds to RETURN.

### l. Displayed Contents on the Image

FIG. 11 is a diagram showing an image where the display is stopped on the display 32.

In this embodiment, the image on the display 32 includes a left reel 311, a center reel 312, and a right reel 313 as a frame for displaying three symbols, and the fourth reel 314 as a frame for displaying the fourth symbol (FIG. 17, as is described later). FIG. 11 shows that “Bell”, “BAR”, and “Bell” as symbols are in the left reel 311, “Replay”, “Cherry”, and “Blank” as symbols are in the center reel 312, and “Replay”, “Cherry”, and “Red 7” as symbols are in the right reel 313.

FIG. 12 shows that the frame for displaying three symbols (the left reel 311, the center reel 312, and the right reel 313) is in the process of rearranging.

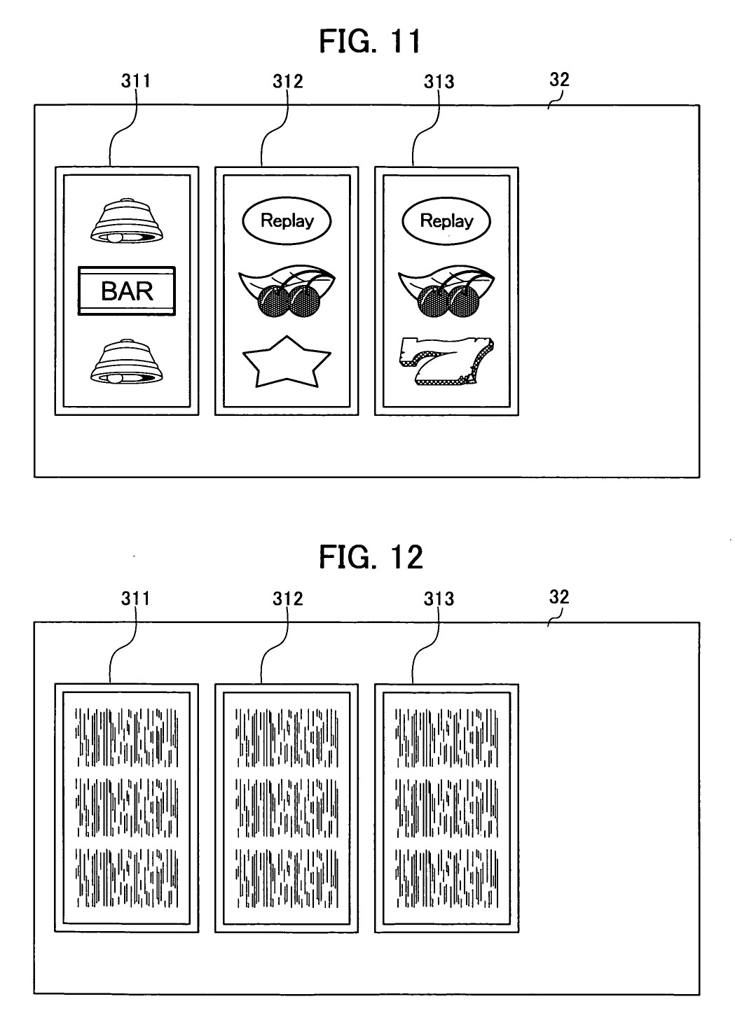

FIG. 13 shows that symbol data are rearranged in the frame for displaying three symbols (the left reel 311, the center reel 312, and the right reel 313) and that each symbol is displayed in each frame. FIG. 13 also shows that a combination of symbols of Level 5 is established, because “Cherry”, “Cherry”, and “ANY (Red 7)” on the award line are rearranged.

FIG. 14 shows that a door 320 to the frame for displaying the fourth symbol has emerged after rearranging the symbol data in the frame for displaying three symbols.

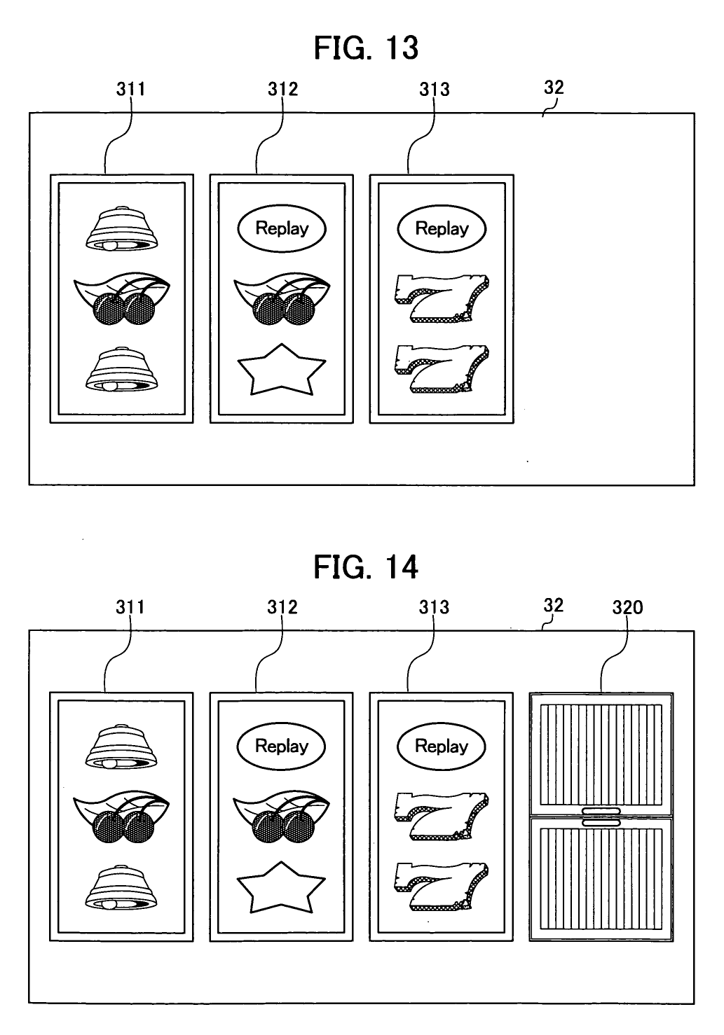

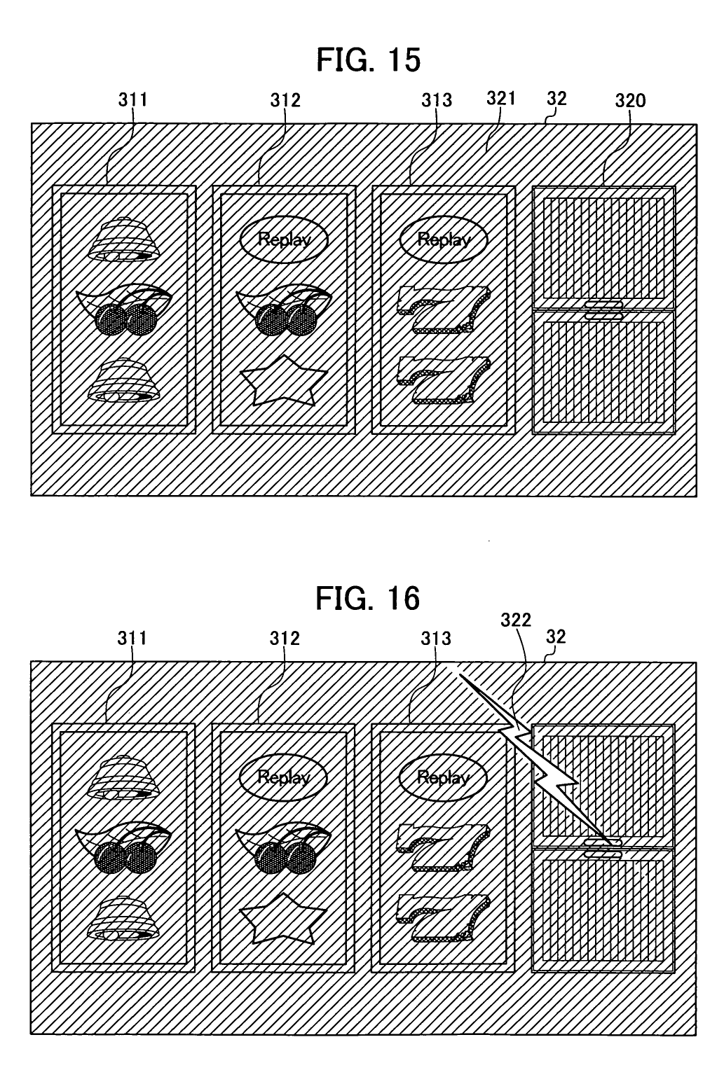

FIG. 15 shows displaying images for introducing the frame for displaying the fourth symbol. The entire image of the display 32 becomes darker and this notifies that the frame for displaying the fourth symbol will emerge.

FIG. 16 shows an image where lightning 322 hits the door 320 to the frame for displaying the fourth symbol. Therefore, FIG. 16 shows the image where the door 320 is opened by being hit by the lightning 322 to the frame for displaying the fourth symbol.

FIG. 17 shows that the lightning 322 hits the door 320 to the frame for displaying the fourth symbol, then the door 320 is opened, and the frame for displaying the fourth symbol (the fourth reel 314) emerges. The message “Mystery Chance” 316 is displayed.

FIG. 18 shows that the door 320 is opened and the fourth reel 314 emerges as the frame for displaying the fourth symbol. A sword 315 is displayed in the frame for displaying the fourth symbol (the fourth reel 314). It shows the image that a treasure may emerge.

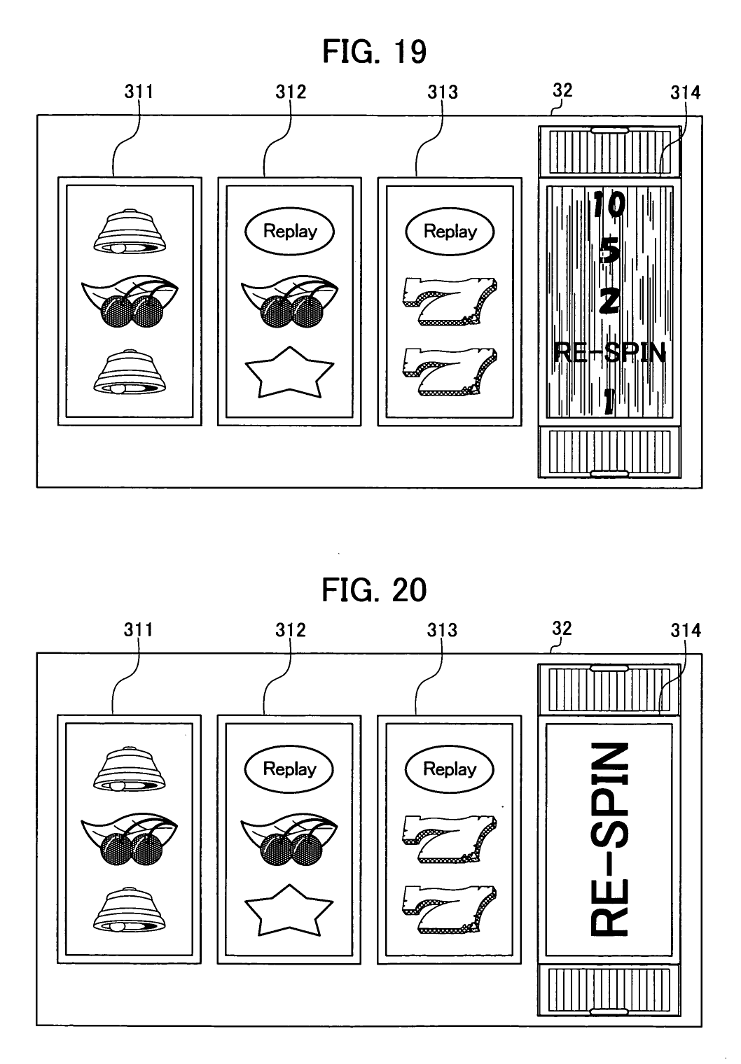

FIG. 19 shows that the frame for displaying the fourth symbol (the fourth reel 314) is spinning. It also shows that one of “1”, “Re-spin”, “2”, “5”, and “10” can be displayed.

FIG. 20 shows that spinning of the frame for displaying the fourth symbol (the fourth reel 314) is over and “Re-spin” is displayed.

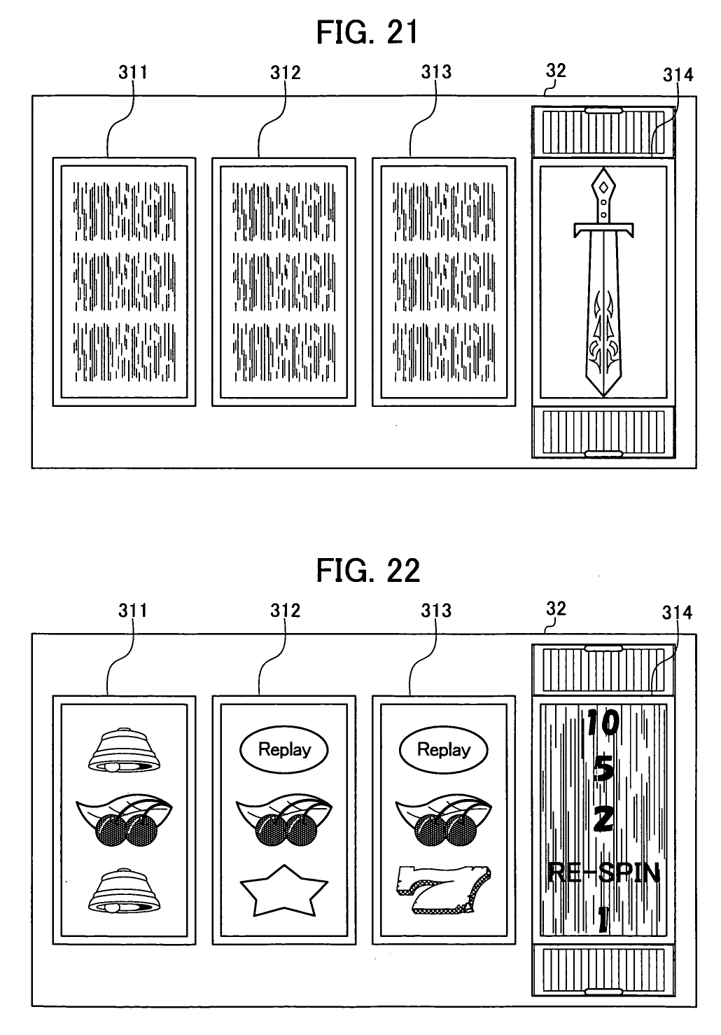

Since the frame for displaying the fourth symbol (the fourth reel 314) displays “Re-spin” and its spinning is over, FIG. 21 shows that symbols are right in the process of rearranging in the frame for displaying three symbols (the left reel 311, the center reel 312, and the right reel 313).

FIG. 22 shows that the frame for displaying the fourth symbol is spinning again after the symbols has been rearranged in the frame for displaying three symbols (the left reel 311, the center reel 312, and the right reel 313). It also shows that a combination of symbols of Level 3 (“Cherry”, “Cherry”, and “Cherry”) is now established, which is higher than that of Level 5 (“Cherry”, “Cherry”, and “ANY”), which is a previous combination of symbols before being rearranged.

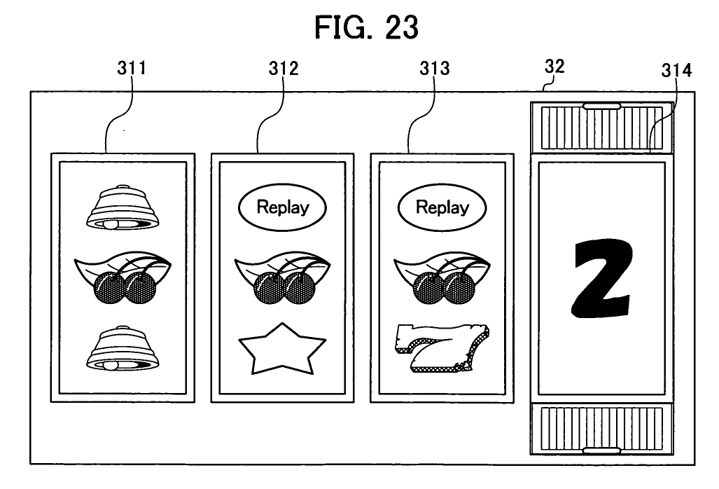

FIG. 23 shows that spinning of the frame for displaying the fourth symbol (the fourth reel 314) is over and the frame displays “2”. Regarding providing an award, since “Cherry”, “Cherry”, and “Cherry” are displayed in the frame for displaying three symbols, it corresponds to 15 medals based on the award table, and further, since the frame for displaying the fourth symbol (the fourth reel 314) displays “2”, 30 medals are awarded.

According to the present embodiments, the following operations and effects are made.

According to the video slot machine 10 of the present embodiment, a start of the game is accepted, a plurality of symbol data are determined randomly, and a first game, which rearranges a plurality of symbol data decided in the frame for displaying the three symbols (the left reel 311, the center reel 312, and right reel 313) of the display 32, is performed. Afterwards, the invention performs a separate determination, based on the determination, newly introduces the frame for displaying the fourth symbol (the fourth reel 314) on the display 32 accompanied with images to be displayed (FIGS. 14 to 17), and displays the images to notify the possibility of an award (FIGS. 18 to 20). Then, the invention randomly determines symbol data to be displayed in the frame for displaying the fourth symbol (the fourth reel 314) separately from the first game. When the symbol is a specific symbol (Re-spin), the invention performs a second game which further rearranges the rearranged first game, and provides an award in response to the contents of the symbol data which result from the rearrangement in the frame for displaying the three symbols (the left reel 311, the center reel 312, and the right reel 313). In this way, the present invention can raise more players' expectations by rearranging in the state of rearrangement and can further improve entertainment properties by newly introducing the frame for displaying a symbol which can lead to rearranging on the display, accompanied with images to be displayed.

Although, in the embodiment, it is described that an award is provided in response to the contents of the symbol data which are rearranged in the frame for displaying the Nth symbols based on the result of the second game, the invention can also provide an award in response to the contents of the symbol data which are rearranged in the frame for displaying the Nth symbols based on the result of the first game, display Re-spin in the frame for displaying N+1th symbol, and further, give a second round of an award in response to the contents of the symbol data which are rearranged in the frame for displaying the Nth symbol. According to the foregoing, the present invention can further improve entertainment properties.

Although, in the embodiment, the frame for displaying the Nth symbol is, for example, the frame for displaying three symbols, the number of symbols in the frame is not limited. Therefore, the present invention can further improve entertainment properties.

In addition to the video slot machine 10 of the present embodiment, the present invention can be applied to another gaming machine such as a pachi-slot machine. In this case, the present invention newly displays a frame for displaying an N+1th symbol on a transparent liquid crystal display provided in front of a mechanical reel. The present invention can also hide the mechanical reel which are located on the back of the transparent liquid display by the transparent liquid display, and can newly introduce the frame for displaying the N+1th symbol. According to the foregoing, the present invention can further improve entertainment properties.

Although the embodiments are explained in the above descriptions, the present invention is not limited to those, and various changes and modifications of design can be made within the scope of the claims.

What is claimed is:

1. A gaming machine comprising:
a memory for storing symbol data corresponding to a plurality of types of symbols used in a game;
a display device having N frames for displaying symbols and an N+1th frame for displaying a symbol separately from the N frames; and
a controller configured with logic to:
(a) accept a start of the game, and randomly determine a plurality of symbol data;
(b) cause the display device to display symbols in the N frames in accordance with the determined plurality of symbol data so as to perform a first game;
(c) randomly determine symbol data to be used for the N+1th frame separately from the first game, and cause the display device to display a symbol in the N+1th frame in accordance with the determined symbol data;
(d) when the displayed symbol is a specific symbol, randomly determine a plurality of symbol data and cause the display device to display symbols in the N frames in accordance with the determined plurality of symbol data so as to perform a second game with rearrangement; and
(e) provide an award in accordance with the symbols rearranged in the N frames.

2. The gaming machine according to claim 1, wherein the controller provides for the second game a higher award than an award to which the first game is entitled.

3. A gaming machine comprising:
a memory for storing symbol data corresponding to a plurality of types of symbols used in a game;
a display device having N frames for displaying symbols and an N+1th frame for displaying a symbol separately from the N frames; and
a controller configured with logic to:
(a) accept a start of the game, and randomly determine a plurality of symbol data;
(b) cause the display device to display symbols in the N frames in accordance with the determined plurality of symbol data so as to perform a first game;
(c) perform a determination;
(d) cause the display to display the N+1th frame in accordance with the determination;
(e) randomly determine symbol data to be used for the N+1th frame separately from the first game, and cause the display device to display a symbol in the N+1th frame in accordance with the determined symbol data;
(f) when the displayed symbol is a specific symbol, randomly determine a plurality of symbol data and cause the display device to display symbols in the N frames in accordance with the determined plurality of symbol data so as to perform a second game with rearrangement; and
(g) provide an award in accordance with the symbols rearranged in the N frames.

4. The gaming machine according to claim 3, wherein the controller provides for the second game a higher award than an award to which the first game is entitled.

5. A gaming machine comprising:
a memory for storing symbol data corresponding to a plurality of types of symbols used in a game;
a display device having N frames for displaying symbols and an N+1th frame for displaying a symbol separately from the N frames; and
a controller configured with logic to:
(a) accept a start of the game, and randomly determine a plurality of symbol data;
(b) cause the display device to display symbols in the N frames in accordance with the determined plurality of symbol data so as to perform a first game;
(c) perform a determination;
(d) cause the display to display the N+1th frame with rendered effects in accordance with the determination and information related to notification of a possible win;
(e) randomly determine symbol data to be used for the N+1th frame separately from the first game, and cause the display device to display a symbol in the N+1th frame in accordance with the determined symbol data;
(f) when the displayed symbol is a specific symbol, randomly determine a plurality of symbol data and cause the display device to display symbols in the N frames in accordance with the determined plurality of symbol data so as to perform a second game with rearrangement; and
(g) provide an award in accordance with the symbols rearranged in the N frames.

6. The gaming machine according to claim 5, wherein the controller provides for the second game a higher award than an award to which the first game is entitled.
